(19) United States
(12) Patent Application Publication
(10) Pub. No.: US 2020/0324759 A1
(43) Pub. Date: Oct. 15, 2020

(54) DRIVING ASSISTANCE APPARATUS

(71) Applicant: DENSO CORPORATION, Aichi (JP)

(72) Inventor: Yasushi SAKUMA, Kariya-city (JP)

(73) Assignees: DENSO CORPORATION, Kariya-city, Aichi-pref. (JP); DENSO CORPORATION, Kariya-city, Aichi-pref. (JP)

(21) Appl. No.: 16/305,906

(22) PCT Filed: Apr. 27, 2017
(86) PCT No.: PCT/JP2017/016677

§ 371 Date: Nov. 30, 2018

(30) Foreign Application Priority Data
Jun. 2, 2016 (JP) 2016-110863
Mar. 15, 2017 (JP) 2017-050297

(51) Int. Cl. B60W 30/09; G06K 9/00; B60W 40/09; B60W 50/14

(52) U.S. Cl. CPC B60W 30/09; G06K 9/00791; B60W 40/09; B60W 2554/4041; B60W 2050/143; B60W 2554/4049; B60W 2554/4045; B60W 50/14

(57) ABSTRACT

A driving assistance apparatus includes: a traveling state detection unit of a vehicle; a rear condition detection unit that detects a status relating to a moving object behind the vehicle; a checking action detection unit that detects an action of a driver of the vehicle for checking behind the vehicle; a deceleration detection unit that detects deceleration of the vehicle; a notification unit that performs notification to the driver; and a control unit that controls the notification unit to perform the notification to the driver when the vehicle decelerates in a case where a condition that: the vehicle is in a traveling state; the moving object is disposed within the predetermined range behind the vehicle; and the driver has not checked behind the vehicle continues for a predetermined time.

### CROSS REFERENCE TO RELATED APPLICATIONS

This application is based on Japanese Patent Applications No. 2016-110863 filed on Jun. 2, 2016, and No. 2017-050297 filed on Mar. 15, 2017, the disclosures of which are incorporated herein by reference.

### TECHNICAL FIELD

The present disclosure relates to a driving assistance apparatus.

### BACKGROUND ART

A technique that urges a driver to pay attention to a condition behind the own vehicle has been conventionally known. For example, Patent Literature 1 discloses a technique that alerts a driver when another vehicle is present behind the own vehicle, and it is considered that the driver of the own vehicle is unaware of the other vehicle.

### PRIOR ART LITERATURES

### Patent Literature

Patent Literature 1: JP-2015-125686-A

### SUMMARY OF INVENTION

The technique disclosed in Patent Literature 1 alerts the driver every time a state such as the position or the speed of another vehicle which is located behind the own vehicle changes. Thus, the alert is executed more than necessary depending on a road condition, which may annoy the driver.

It is an object of the present disclosure to provide a driving assistance apparatus capable of reducing annoyance for a driver and reducing risk caused by failing to check behind at the same time.

According to an aspect of the present disclosure, a driving assistance apparatus includes: a traveling state detection unit that detects a traveling state of a vehicle; a rear condition detection unit that detects a status relating to a moving object other than the vehicle within a predetermined range behind the vehicle; a checking action detection unit that detects an action of a driver of the vehicle for checking behind the vehicle; a deceleration detection unit that detects deceleration of the vehicle; a notification unit that performs notification to the driver; and a control unit that controls the notification unit to perform the notification to the driver, based on detection results of the traveling state detection unit, the rear condition detection unit and the checking action detection unit, when the deceleration detection unit detects the deceleration of the vehicle in a case where a condition that: the vehicle is in a traveling state; the moving object is disposed within the predetermined range behind the vehicle; and the driver has not checked behind the vehicle continues for a predetermined time.

In the above driving assistance apparatus, the notification is performed to the driver when the own vehicle decelerates under the condition where it is considered that a safety check behind the own vehicle before deceleration has not been performed. Thus, no notification is performed when the driver has performed a safety check behind the own vehicle. Thus, it is possible to reduce annoyance for the driver while reducing the risk caused by failing to check behind the vehicle.

### BRIEF DESCRIPTION OF DRAWINGS

The above and other objects, features and advantages of the present disclosure will become more apparent from the following detailed description made with reference to the accompanying drawings. In the drawings:

FIG. 1 is a diagram illustrating an example of a schematic configuration of a driving assistance apparatus according to a first embodiment;

FIG. 2 is a flowchart illustrating an example of the flow of a process in an ECU according to the first embodiment;

FIG. 3 is a flowchart illustrating an example of the flow of the process in the ECU according to the first embodiment;

FIG. 4 is a diagram illustrating an example of a first range according to the first embodiment;

FIG. 5 is a diagram illustrating an example of the disposition relationship between the first range and a second range according to the first embodiment;

FIG. 6 is a flowchart illustrating a process of deceleration determination for the own vehicle according to the first embodiment;

FIG. 7 is a flowchart illustrating a process of determining a determination period of deceleration determination according to a second embodiment;

FIG. 8 is a flowchart illustrating an example of the flow of a process in an ECU according to a third embodiment; and

FIG. 9 is a flowchart illustrating an example of the flow of the process in the ECU according to the third embodiment.

### EMBODIMENTS FOR CARRYING OUT INVENTION

A plurality of embodiments and modifications for the disclosure will be described with reference to the drawings. For convenience of description, a part having the same function as a part illustrated in the drawing used in the preceding description will be designated by the same reference sign as the preceding part between the embodiments and modifications, and description thereof may be omitted. Description in the other embodiments and/or modifications can be referred to for the parts having the same reference signs. The directions such as the front and the rear used in the description are based on front, rear, right, and left directions for a driver who drives an own vehicle unless otherwise specifically noted.

### First Embodiment

Hereinbelow, a first embodiment will be described with reference to the drawings.

A driving assistance apparatus 1 is mounted on an own vehicle V which is an automobile, and performs notification (described below) to a driver of the own vehicle V.

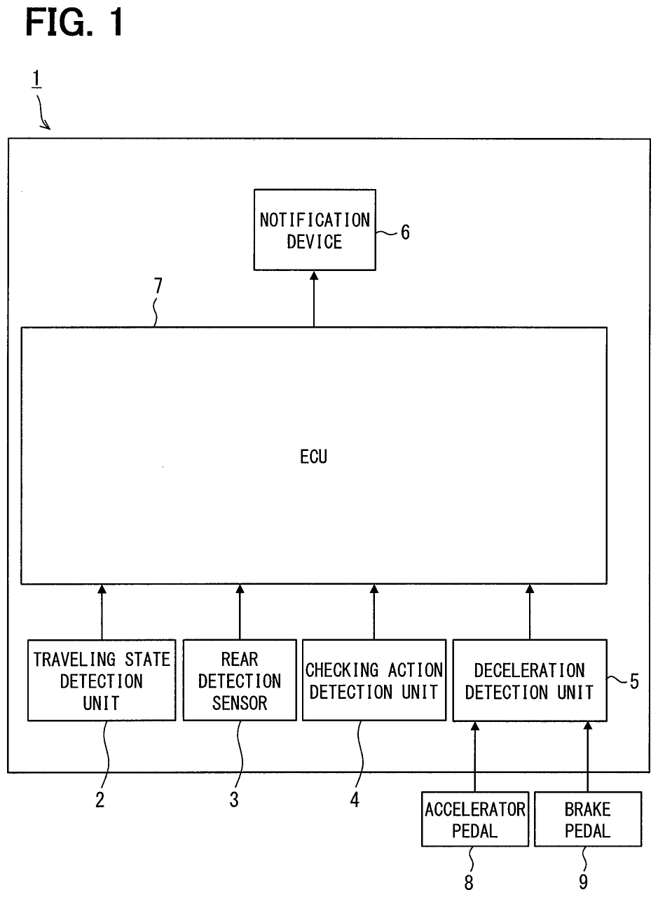

As illustrated in FIG. 1, the driving assistance apparatus 1 includes a traveling state detection unit 2, a rear detection sensor 3, a checking action detection unit 4, a deceleration detection unit 5, a notification device 6, and an ECU 7. The deceleration detection unit 5 is connected to an accelerator pedal 8 and a brake pedal 9.

The traveling state detection unit 2 detects a traveling state of the own vehicle V and outputs the detected traveling state to the ECU 7 (described below). The traveling state described herein indicates whether the own vehicle V is in a traveling state or a stopped state. Further, in the traveling state, there is a distinction between forward traveling and backward traveling.

In order to detect the traveling state, a speed or an acceleration in traveling of the own vehicle V is detected or calculated. For example, a speed sensor can be used in the calculation of the speed of the own vehicle V. There is known a speed sensor that detects a rotation speed of an axle shaft of the own vehicle V by a pulse generator which is attached to the axle shaft and calculates the speed of the own vehicle V on the basis of the detected rotation speed. An acceleration sensor can be used in the calculation of the acceleration of the own vehicle V. Suitably, the acceleration sensor is attached to the body of the own vehicle V and detects an acceleration generated by acceleration or deceleration of the own vehicle V. The traveling state detection unit 2 detects a value of the speed or the acceleration of the own vehicle V in traveling of the own vehicle V by using the speed sensor or the acceleration sensor.

When the speed is zero, it can be determined that the own vehicle V is in a stopped state. Also when there is no change in the acceleration in the vehicle front-rear direction for a certain time, it can be determined that the own vehicle V is in a stopped state. When the own vehicle V is traveling, although there is a state in which the speed becomes approximately constant, it is difficult to drive the own vehicle Vat a completely constant speed. Thus, also when there is no change in the acceleration in the vehicle front-rear direction, it can be determined that the own vehicle V is in a stopped state. In a state in which the own vehicle V is traveling, it is determined whether the traveling is forward traveling or backward traveling, for example, from a shift position. The traveling state detection unit 2 corresponds to a traveling state detection unit.

The rear detection sensor 3 detects the presence or absence of a moving object behind the own vehicle V and outputs the detected presence or absence of a moving object to the ECU 7 (described below). The moving object described herein is not limited to a vehicle such as an automobile or a two-wheeled vehicle, and also includes a pedestrian. In the present embodiment, an example in which the moving object is an automobile is described. Hereinbelow, for convenience, the moving object is referred to as a rear vehicle R. The rear detection sensor 3 corresponds to a rear condition detection unit.

The rear detection sensor 3 detects not only the presence or absence of the rear vehicle R, but also a relative positional relationship between the own vehicle V and the rear vehicle R, and outputs the detected relative positional relationship to the ECU 7. The relative positional relationship described herein may be the distance between the own vehicle V and the rear vehicle R or the azimuth in which the rear vehicle R is present with respect to the traveling direction of the own vehicle V. For example, a radar sensor or a sonar can be used in the calculation of the distance between the own vehicle V and the rear vehicle R and the azimuth in which the rear vehicle R is present. When the distance between the own vehicle V and the rear vehicle R and the azimuth in which the rear vehicle R is present are calculated, the presence or absence of an object behind the own vehicle V is also detected.

For example, a millimeter wave radar device which uses radio waves in a millimeter wave band can be used as the radar sensor. Suitably, the millimeter wave radar device includes two or more reception antennas which are disposed on the center of the rear end of the own vehicle V and have different directivities, and receives a reflected wave of a transmitted millimeter wave to scan a substantially sector range. The sonar may be any sonar that pulse-transmits an ultrasonic wave from each of two transducers which are attached with a predetermined distance therebetween to a rear bumper of the own vehicle V, receives a reflected wave from an object, and measures a time from the transmission to the reception to calculate the distance from each of the transducers to the object. The sonar may be configured to measure the relative position of the object with respect to the own vehicle V by performing triangulation using the calculated distance. The radar sensor or the sonar used in the detection of the relative positional relationship between the own vehicle V and the rear vehicle R corresponds to a relative position calculation unit.

The checking action detection unit 4 detects a condition of checking behind by the driver of the own vehicle V and outputs the detected condition to the ECU 7 (described below). The condition of checking behind described herein indicates the presence or absence of an action of checking behind such as an action of the driver visually checking a rearview mirror or a side mirror or an action of the driver turning his/her face to the rear and directly visually checking behind. The detection of the condition of checking behind can be performed, for example, by capturing an image of the face of the driver from the opposite direction and extracting the direction of the face or the direction of the line of sight from the captured image. For example, a camera that is disposed at a position close to the front of a driver's seat such as near a meter or on a steering column is suitably used to capture an image of the face of the driver. A known extraction algorithm can be used as a method for extracting the direction of the face or the direction of the line of sight of the driver from a captured image. The action of checking behind to be detected is not limited to these actions. For example, a camera (not illustrated) may be disposed outside the own vehicle V, an image which is captured by the camera and represents a rear condition may be projected on a display device (not illustrated) which is disposed inside the own vehicle V, and an action of the driver checking the display device may be detected. The checking action detection unit 4 corresponds to a checking action detection unit.

The deceleration detection unit 5 detects deceleration of the own vehicle V and outputs the detected deceleration to the ECU 7 (described below). The deceleration detection unit 5 is configured to be connectable to at least one of the accelerator pedal 8 and the brake pedal 9. The deceleration of the own vehicle V described herein may include a case where the own vehicle V decelerates as a result of a driving operation by the driver with an intention of decelerating and a case where the own vehicle V decelerates due to a road surface on which the own vehicle V travels or the like.

The deceleration detection unit 5 includes a deceleration operation detection unit which detects a deceleration operation which is a driving operation by the driver with an intention of decelerating. The driving operation by the driver with an intention of decelerating includes, for example, a case where pressing on the accelerator pedal 8 is eased up and a case where the brake pedal 9 is pressed. A known accelerator position sensor which detects the position of the accelerator pedal 8 using a Hall IC or the like can be used in the detection of the pressed amount of the accelerator pedal 8. A stroke sensor which measures the stroke amount of the brake pedal 9 can be used in the detection of an operation on the brake pedal 9. The deceleration operation detection unit corresponds to a deceleration operation detection unit.

Next, for example, a case where the vehicle V approaches an upward slope during traveling, and a road grade becomes large can be considered as the case where the own vehicle V decelerates due to a road surface on which the vehicle V travels or the like. Such deceleration caused by an external factor can be detected on the basis of changes with time in the speed or the acceleration of the own vehicle V. A result of detection by the traveling state detection unit 2 described above may be used as the speed or the acceleration of the own vehicle V. The deceleration detection unit 5 corresponds to a deceleration detection unit.

The notification device 6 is disposed inside the own vehicle V, and performs notification to the driver. The notification is preferably performed using, for example, a display, a sound, or vibrations so as to attract the attention of the driver during driving. More specifically, for example, an onboard display or an HUD unit which is used in a navigation device (not illustrated) or the like, a speaker, a buzzer, an LED, or a vibrator which is buried in a vehicle seat or a steering wheel can be used. The notification device 6 corresponds to a notification unit.

The notification includes two types of notifications according to the degree of urgency thereof. Specifically, “alert” and “warning” having a higher urgency than the alert are set.

The alert is used to urge the driver to pay attention to the current condition, although the current condition does not immediately lead to an accident. For example, a voice message such as “a vehicle is present behind, please pay attention” may be output as the notification in this case.

The warning is used when a prompt reaction of the driver is required, for example, when the distance between the own vehicle V and the rear vehicle R is short, and there is a high possibility of collision with the rear vehicle R by deceleration of the own vehicle V. The notification in this case requires application of a stronger stimulus than the alert to the driver. For example, a buzzer may be sounded, an HUD or an LED may be used to emit light or perform a blinking operation in sight of the driver, or a vibrator may be used to apply vibrations.

The electronic control unit (ECU) 7 includes a CPU and various memories (not illustrated). The ECU 7 executes a series of processes relating to the notification to the driver in accordance with input from the traveling state detection unit 2, the rear detection sensor 3, the checking action detection unit 4, and the deceleration detection unit 5 described above. The ECU 7 corresponds to a control unit.

The ECU 7 determines whether the own vehicle V is traveling on the basis of input from the traveling state detection unit 2. When the determination is performed on the basis of the speed of the own vehicle V, it can be determined that the own vehicle V is traveling when the speed of the own vehicle V detected by the speed sensor is higher than 0 km/h. It can be determined whether the own vehicle V is traveling also from the acceleration of the own vehicle V detected by the acceleration sensor.

The ECU 7 determines whether the detected rear vehicle R is present within a predetermined range (described below) on the basis of input from the rear detection sensor 3.

The ECU 7 determines whether the driver appropriately checks behind on the basis of a condition of checking behind by the driver input from the checking action detection unit 4. Specifically, an elapsed time from when the driver checks behind last time to the current time is measured. When the elapsed time is equal to or longer than a predetermined time, it is determined that the driver does not appropriately check behind.

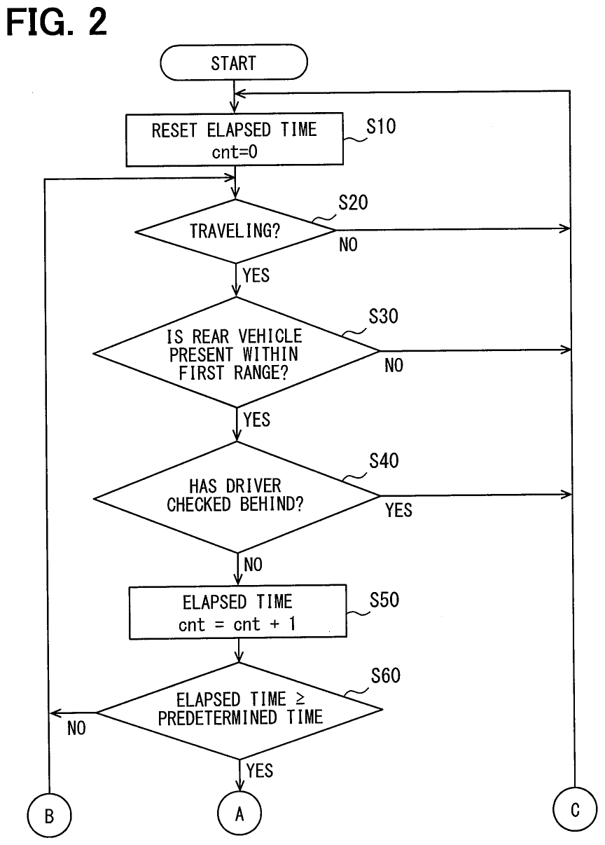

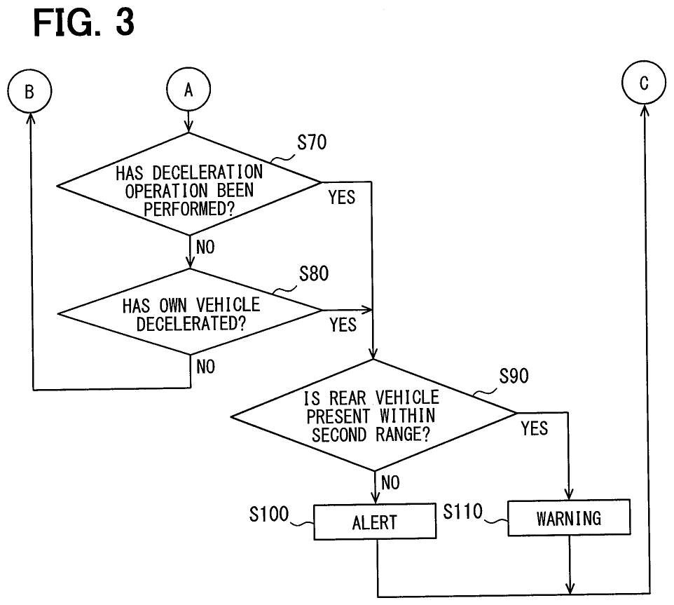

Next, the series of processes executed by the ECU 7 will be described with reference to a flowchart illustrated in FIGS. 2 and 3.

First, in step S10, a counter cnt for counting an elapsed time from when the driver checks behind last time is reset to 0 (cnt=0).

Next, in step S20, it is determined whether the own vehicle V is traveling. When it is determined that the own vehicle V is not traveling, the process returns to step S10. When it is determined that the own vehicle V is traveling, the process shifts to step S30.

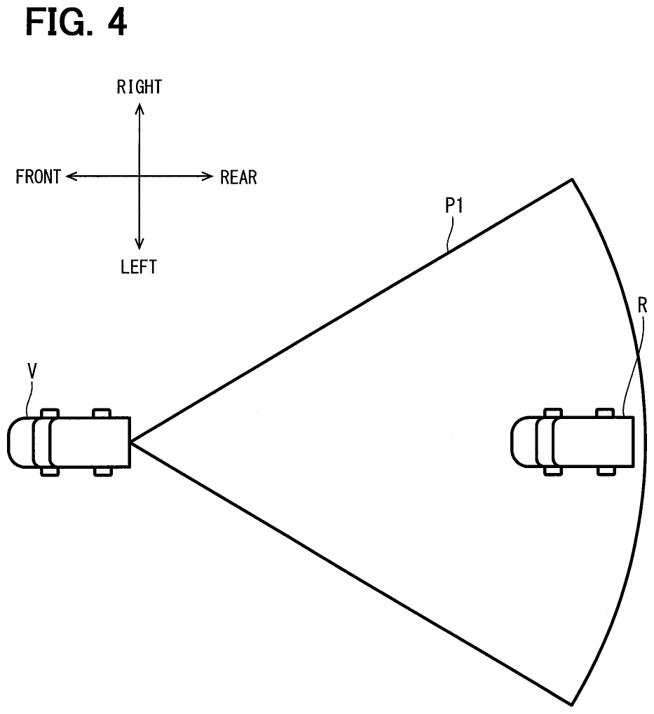

In step S30, it is determined whether the rear vehicle R is present within a first range P1 illustrated in FIG. 4 on the basis of input from the rear detection sensor 3. The first range P1 is a range where the driver should check the presence or absence of the rear vehicle R. More specifically, the first range P1 is set in a sector shape centered at the rear end of the own vehicle V. The radius of the first range P1 is set to 30 meters. However, the radius of the first range P1 is not limited to 30 meters, and may be appropriately determined according to the vehicle. When it is determined that the rear vehicle R to be detected is not present within the first range P1, the process returns to step S10. When it is determined that the rear vehicle R to be detected is present within the first range P1, the process shifts to step S40.

In step S40, it is determined whether the driver has checked a condition behind the own vehicle V on the basis of input from the checking action detection unit 4. When it is determined that the driver has checked a condition behind the own vehicle V, the process returns to step S10. When it is determined that the driver has not checked a condition behind the own vehicle V, the process shifts to step S50.

In step S50, a count is added to the counter cnt. After the adding process is performed, the process shifts to step S60. A count is added to the counter cnt every time the processes from step S20 to step S50 are performed once. Accordingly, the counter cnt indicates a duration of a state in which the own vehicle V is traveling, the rear vehicle R is present within the first range P1 behind the own vehicle V, and the driver has not checked behind.

In step S60, it is determined whether the counter cnt is equal to or more than a predetermined time. Here, the predetermined time is set to a value corresponding to 5 seconds. However, the predetermined time is not limited to 5 seconds, and may be appropriately determined taking a vehicle condition or the like into consideration. When a result of the determination shows that the counter cnt is less than the predetermined time, the process returns to step S20. When the counter cnt is equal to or more than the predetermined time, the process shifts to step S70.

In step S70, it is determined whether the driver has performed a deceleration operation on the basis of input from the deceleration detection unit 5. On the basis of the detected pressed amount of the accelerator pedal 8, when the driver has eased up the pressing of the accelerator pedal 8, it is determined that the driver has performed a deceleration operation. When the determination is performed on the basis of a brake operation, when the stroke amount of the brake pedal 9 has increased and it is determined that the brake pedal 9 has been pressed, it is determined that the driver has performed a deceleration operation. When it is determined that no deceleration operation has been performed, the process shifts to step S80. When it is determined that a deceleration operation has been performed, the process shifts to step S90.

In the next step S80, it is determined whether the speed of the own vehicle V has actually decreased on the basis of input from the deceleration detection unit 5. Here, as described above, the determination is performed on the basis of changes with time in the speed of the own vehicle V derived from a result of detection by the traveling state detection unit 2. More specifically, the determination is performed using a deceleration determination flow (described below). When it is determined that the speed of the own vehicle V has decreased, the process shifts to step S90. When it is determined that the speed of the own vehicle V has not decreased, the process returns to step S20.

According to the above process, when the driver has performed a deceleration operation or the speed of the own vehicle V has decreased under the condition where a state in which the own vehicle V is traveling, the rear vehicle R is present within the first range P1 behind the own vehicle V, and the driver has not checked behind continues for the predetermined time, the process shifts to step S90.

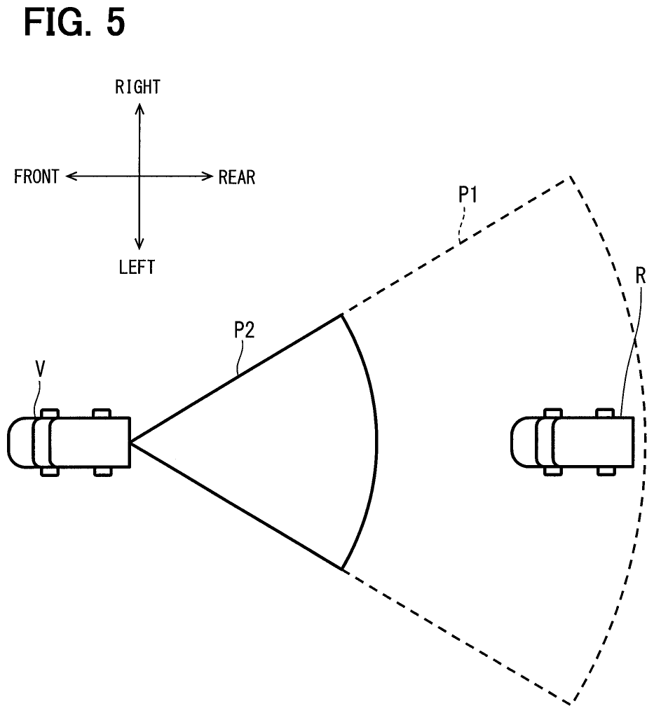

Then, in step S90, the presence or absence of the rear vehicle R within a second range P2 which is a part of the first range P1, the part being close to the own vehicle V, is determined on the basis of input from the rear detection sensor 3. As illustrated in FIG. 5, the second range P2 is set in a sector shape centered on the rear end of the own vehicle V within the first range P1. The radius of the second range P2 is set to a range of 10 meters. However, the radius of the second range P2 is not limited to 10 meters, and may be appropriately determined according to the vehicle. The determination of step S90 is performed when the rear vehicle R is present within the first range P1. Thus, the determination of step S90 determines the relative positional relationship between the own vehicle V and the rear vehicle R, in particular, determines whether the relative distance is equal to or less than the radius of the second range P2, or whether the relative distance is longer than the radius of the second range P2 and shorter than the radius of the first range P1.

When it is determined that the rear vehicle R is not present within the second range P2, the process shifts to step S100. When it is determined that the rear vehicle R is present within the second range P2 in step S90, the process shifts to step S110.

In step S100, the notification device 6 performs the alert described above to the driver. In step S110, the notification device 6 performs the warning described above to the driver.

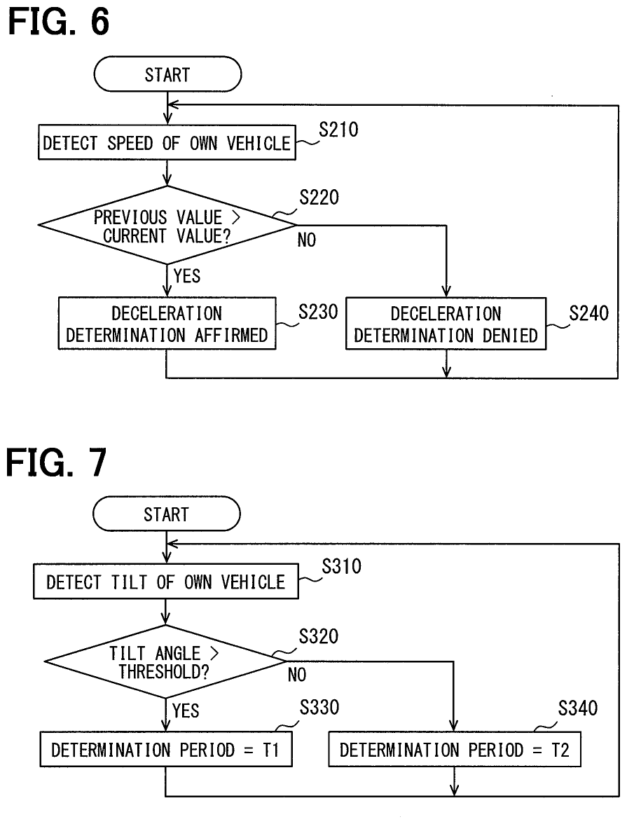

Next, the deceleration determination for the own vehicle V which is performed in step S80 will be described in detail with reference to FIG. 6. The flow illustrated in FIG. 6 is constantly repeatedly executed on the ECU 7 in parallel to the main flow illustrated in FIGS. 2 and 3.

First, in step S210, the speed of the own vehicle V is detected on the basis of input from the traveling state detection unit 2. Then, the detected speed is recorded in a recording unit (not illustrated) which is included in the ECU 7. The recording unit includes a ring buffer which records input values in the order of input and sequentially performs overwriting on the oldest value when recorded contents reach a set upper limit. After the detected speed of the own vehicle V is recorded in the recording unit, the process shifts to step S220.

In step S220, the latest speed value and the second latest speed value are read from the recording unit and compared. A result of the comparison shows that when the speed has decreased, the process shifts to step S230, and it is determined that the vehicle V has decelerated. When a result of the comparison shows that the speed has not changed or has increased, the process shifts to step S240, and it is determined that the own vehicle V has not decelerated.

A volatile recording medium which holds a value only during energization of the ECU 7 is preferably used as the recording unit. When the volatile recording medium is used, only one value of the speed of the own vehicle V is recorded when the determination of S220 is performed immediately after the start of energization of the ECU 7. Thus, comparison cannot be performed. In such a case, at least it cannot be considered that the own vehicle V decelerates. Thus, the process may shift to step S240.

According to the configuration of the first embodiment described above, notification is performed to the driver when the own vehicle V decelerates in a state in which the own vehicle V is traveling, the rear vehicle R is present within the predetermined range which is set behind the own vehicle V, and the driver has not checked behind for the predetermined time. Thus, when the own vehicle V decelerates under a dangerous condition where the driver fails to check behind, the driver receives the notification. Accordingly, the driver receives no excessive notification, and annoyance for the driver can be reduced. Further, it is possible to appropriately perform notification for a dangerous condition. Thus, it is possible to reduce the risk at the same time.

In the configuration of the first embodiment, the deceleration of the own vehicle V is determined in the two stages of a deceleration operation by the driver and a decrease in the speed of the own vehicle V. Accordingly, when a deceleration operation by the driver is detected, notification can be performed in the stage before the operation is reflected in the speed of the own vehicle V. Thus, it is possible to further reduce the risk. In addition, even when the speed of the own vehicle V decreases regardless of a deceleration operation by the driver, notification is performed to the driver. Thus, it is possible to more reliably reduce the risk.

In the configuration of the first embodiment, it is determined whether alert notification is performed or warning notification is performed according to whether the rear vehicle R is present within the second range P2 with respect to the own vehicle V. That is, contents of the notification are changed according to the range in which the rear vehicle R is present. Accordingly, it is possible to selectively perform warning notification having a high urgency and alert notification. Thus, the driver can understand the degree of the risk of collision with the rear vehicle R from the contents of the notification.

### Second Embodiment

Hereinbelow, a second embodiment will be described with reference to the drawings.

A traveling state detection unit 2 in the second embodiment detects or calculates a tilt angle of the own vehicle V with respect to a horizontal plane, in addition to detect or calculate a speed or an acceleration in traveling of the own vehicle V, to detect a traveling state. Then, a determination period of the deceleration determination for the own vehicle V illustrated in FIG. 6 described in the first embodiment is determined on the basis of the detected tilt angle. The traveling state detection unit 2 in the second embodiment includes a tilt angle sensor (not illustrated) for detecting or calculating the tilt angle of the own vehicle V with respect to the horizontal plane. For example, a known gyro sensor can be used as the tilt angle sensor. A kwon detection algorithm can be used as a method for detecting the tilt angle of the own vehicle V.

Next, a series of processes according to the determination of the period of the deceleration determination executed by an ECU 7 will be described with reference to a flowchart illustrated in FIG. 7. The flow illustrated in FIG. 7 is constantly repeatedly executed on the ECU 7 in parallel to the main flow illustrated in FIGS. 2 and 3 and the deceleration determination flow illustrated in FIG. 6.

First, in step S310, the tilt angle of the own vehicle V with respect to the horizontal direction is detected on the basis of input from the tilt angle sensor described above. The tilt angle described herein is an angle between a virtual straight line that connects a front wheel to a rear wheel of the own vehicle V and the horizontal direction.

Then, in step S320, the tilt angle detected in step S310 is compared with a predetermined threshold to determine whether the tilt angle is larger than the predetermined threshold. Here, the predetermined threshold is set to 6 degrees. However, the threshold is not limited to 6 degrees, and may be appropriately determined taking a vehicle condition or the like into consideration. When a result of the comparison shows that the tilt angle is larger than the predetermined threshold, the process shifts to step S330. When the tilt angle is equal to or smaller than the predetermined threshold, the process shifts to step S340.

In step S330, a predetermined determination period t1 is set as the determination period of the deceleration determination. Here, the determination period t1 is set to 0.5 seconds.

In step S340, a predetermined determination period t2 which is longer than the determination period t1 is set as the determination period of the deceleration determination. Here, the determination period t2 is set to 1 second.

According to the above process, the determination period of the deceleration determination is set shorter when the tilt angle of the own vehicle V with respect to the horizontal direction is larger than the predetermined threshold than when the tilt angle is smaller than the predetermined threshold.

For example, when the own vehicle V approaches an upward slope from a flat road, as the grade of the upward slope is larger, the speed of the own vehicle V is more likely to decrease. In the present embodiment, assuming such a case, the determination period of the deceleration determination is shortened when it is considered that the own vehicle V approaches a road having a large grade on the basis of the tilt angle of the own vehicle V.

Accordingly, it is possible to determine whether the own vehicle V has decelerated early. Further, it is possible to reduce the load of the process in the ECU 7 by making the determination period of the deceleration determination long in the other condition.

### Third Embodiment

In a third embodiment, in addition to the “alert” and the “warning”, “notice notifying the presence of a vehicle” is added to the notification to the driver performed in the notification device 6.

The notice notifying the presence of a vehicle is notice for notifying that the rear vehicle R is present behind the own vehicle V. On the other hand, the alert and the warning are alert and warning for notifying the driver of the possibility of collision between the own vehicle V and the rear vehicle R.

In the third embodiment, the timing of performing alert notification to the driver is added.

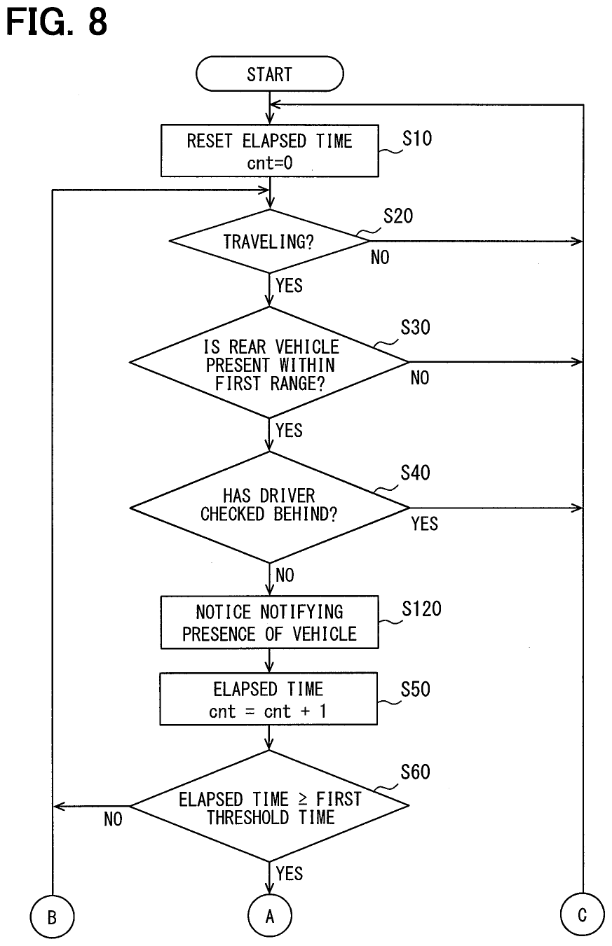

The notice notifying the presence of a vehicle is performed to the driver immediately when a state in which the driver is unaware of the rear vehicle R comes into existence. The state in which the driver is unaware of the rear vehicle R is a state in which the own vehicle V is traveling, the rear vehicle R is present within the first range, and the driver has not checked behind. The “immediately performing the notice” described herein indicates that, as illustrated in FIG. 8, after it is determined whether the driver has checked behind in S40, the notice is executed in the next process (S120) when the determination is NO. A time interval between steps S40 and S120 is shorter than the elapse of the predetermined time used in step S60 of the first embodiment from when it is determined that the driver has not checked behind.

The notice notifying the presence of a vehicle is performed, for example, by displaying an icon or the like on an onboard display or an HUD unit used in a navigation device (not illustrated). The notice notifying the presence of a vehicle can be performed with less annoying the driver by performing the notice not by a voice, but by the display of an icon or the like. When the alert is performed by a display, or a display and a voice, the notice notifying the presence of a vehicle is performed in a mode less annoying the driver than the display of the alert. For example, a mode in which the display is made small or the display color is made inconspicuous is used. The notice notifying the presence of a vehicle may be performed by a voice. In this case, the notice may be performed by a voice less annoying the driver than the alert. For example, the volume of the notice may be made smaller than the volume of the alert or a short voice message may be used.

The notice notifying the presence of a vehicle is capable of notifying the driver that the rear vehicle R is present behind the own vehicle V while reducing annoyance for the driver.

The predetermined time used in step S60 of the first embodiment is defined as a first threshold time. The alert is performed to the driver when the deceleration detection unit 5 detects deceleration of the own vehicle V in a state in which a state unaware of the rear vehicle R continues for the first threshold time. In the third embodiment, in addition to the above, the alert is performed to the driver when a state unaware of the rear vehicle R continues for a second threshold time which is longer than the first threshold time.

When the deceleration detection unit 5 detects deceleration of the own vehicle V in a state in which a state unaware of the rear vehicle R continues for the first threshold time, there may be a high possibility of collision between the own vehicle V and the rear vehicle R.

When the time further elapses in this state, and the state unaware of the rear vehicle R continues for the second threshold time which is longer than the first threshold time, the driver is unaware of the rear vehicle R for a longer time than the case where the first threshold time elapses. During forward traveling, even when a state in which the own vehicle V has not decelerated continues, the driver should drive the own vehicle V while sequentially recognizing the presence of a rear vehicle. The second threshold time is determined in this point of view. Thus, the second threshold time is set longer than the first threshold time.

It is possible to notify the driver of the possibility of collision between the own vehicle V and the rear vehicle R by performing the alert when a state unaware of the rear vehicle R continues for the second threshold time. Accordingly, it is possible to reduce the possibility of collision between the own vehicle V and the rear vehicle R by performing the alert.

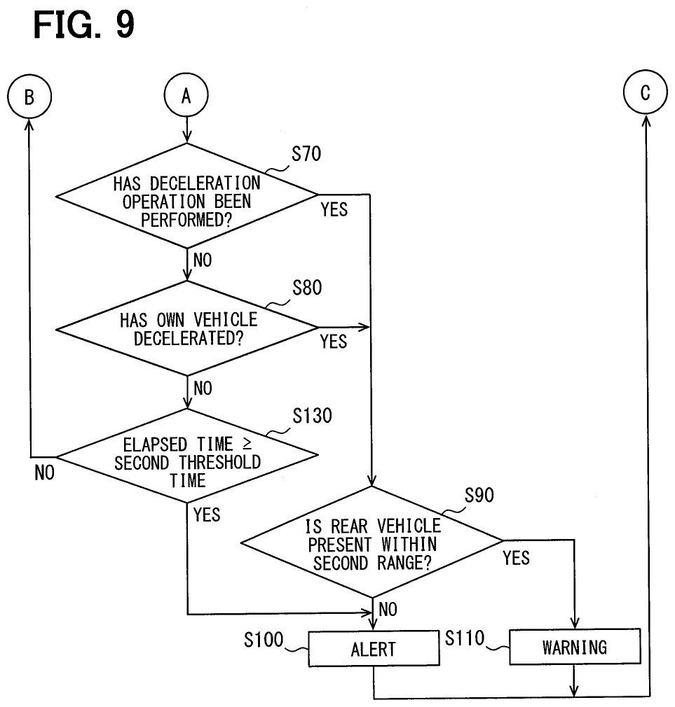

Next, a series of processes executed in an ECU 7 of the third embodiment will be described with reference to a flowchart illustrated in FIGS. 8 and 9. Only change points from the first embodiment and the second embodiment will be described.

When it is determined that the driver has not checked a condition behind the own vehicle V in step S40, the process shifts to step S120.

It is determined whether the driver is unaware of the rear vehicle R by steps S20, S30, and S40.

In step S120, it is determined that the driver is unaware of the rear vehicle R, and notice notifying the presence of the vehicle is performed to the driver. After step S120, the process shifts to step S50.

When it is determined that the speed of the own vehicle V has not decreased in step S80, the process shifts to step S130.

In step S130, it is determined whether a counter cnt indicating an elapsed time is equal to or more than the second threshold time. Here, the second threshold time is set to a value corresponding to 20 seconds. However, the second threshold time is not limited to 20 seconds, and may be appropriately set to any value longer than the first threshold time taking a vehicle condition or the like into consideration. When a result of the determination shows that the counter cnt is less than the second threshold time, the process returns to step S20. When the counter cnt is equal to or more than the second threshold time, the process shifts to step S100.

In step S130, alert is performed to the driver when a state in which the driver is unaware of the rear vehicle R continues for the second threshold time or more even when the state continues for the first threshold time or more and the deceleration detection unit 5 has not detected deceleration of the own vehicle V.

Accordingly, not only when deceleration of the own vehicle V is detected, but also when checking behind, which should be essentially performed by the driver, is neglected, it is possible to urge the driver to check behind.

Modifications

The present disclosure in this specification is not limited to the exemplified embodiments. The present disclosure includes the exemplified embodiments and modified modes based on the exemplified embodiments made by those skilled in the art. For example, the present disclosure is not limited to combinations of components and/or elements described in the embodiments. The present disclosure can be implemented by various combinations.

First Modification

In the above first embodiment, which notification, the alert or the warning, is performed is determined on the basis of whether the rear vehicle R is present within the first range P1 or the second range P2. Alternatively, an area where a rear condition is performed may be divided into more areas, and a plurality of different notifications corresponding to the respective areas may be performed.

Second Modification

In the above first embodiment, the radar sensor or the sonar is used as the rear detection sensor 3 to detect the presence or absence of the rear vehicle R and the relative positional relationship between the own vehicle V and the rear vehicle R. However, the present disclosure is not limited thereto. For example, an optical sensor such as a stereo camera may be used.

Third Modification

In the above second embodiment, any of the two types of determination periods is set by the single determination whether the tilt angle is larger than the predetermined threshold. However, the determination period may be changed according to a value of the tilt angle. For example, as the tilt angle of the own vehicle V with respect to the horizontal plane is steeper, the determination period of the deceleration determination may be set shorter.

Fourth Modification

As the tilt angle sensor, a sensor other than a gyro sensor, specifically, a biaxial or triaxial acceleration sensor which detects an acceleration of at least two axes in the vehicle front-rear direction and the vehicle up-down direction may be used. The angle between the direction in which the gravitational acceleration is generated and the vehicle front-rear direction can be detected by using the biaxial or triaxial acceleration sensor. The direction in which the gravitational acceleration is generated is perpendicular to the horizontal plane. Thus, the tilt angle of the own vehicle V with respect to the horizontal plane can be detected also by using the biaxial or triaxial acceleration sensor.

It is noted that a flowchart or the processing of the flowchart in the present application includes sections (also referred to as steps), each of which is represented, for instance, as S11. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A driving assistance apparatus comprising:
a traveling state detection unit that detects a traveling state of a vehicle;
a rear condition detection unit that detects a status relating to a moving object other than the vehicle within a predetermined range behind the vehicle;
a checking action detection unit that detects an action of a driver of the vehicle for checking behind the vehicle;
a deceleration detection unit that detects deceleration of the vehicle;
a notification unit that performs notification to the driver; and
a control unit that controls the notification unit to perform the notification to the driver, based on detection results of the traveling state detection unit, the rear condition detection unit and the checking action detection unit, when the deceleration detection unit detects the deceleration of the vehicle in a case where a condition that: the vehicle is in a traveling state; the moving object is disposed within the predetermined range behind the vehicle; and the driver has not checked behind the vehicle continues for a predetermined time.

2. The driving assistance apparatus according to claim 1, wherein:
the deceleration detection unit includes a deceleration operation detection unit that detects a deceleration operation of the driver as a driving operation for decelerating the vehicle; and
the deceleration detection unit detects the deceleration of the vehicle based on the deceleration operation detected by the deceleration operation detection unit.

3. The driving assistance apparatus according to claim 2, wherein:
the deceleration operation detection unit detects the deceleration operation based on at least one of an accelerator pedal operation and a brake pedal operation performed by the driver.

4. The driving assistance apparatus according to claim 1, wherein:
the traveling state detection unit detects the traveling state at predetermined intervals; and
the deceleration detection unit determines the deceleration of the vehicle when the traveling state detected by the traveling state detection unit represents the deceleration of the vehicle in comparison with a previous detection result of the traveling state.

5. The driving assistance apparatus according to claim 4, wherein:
the traveling state includes a tilt angle of the vehicle with respect to a horizontal direction; and
the control unit sets an interval of detecting the traveling state by the traveling state detection unit based on the tilt angle.

6. The driving assistance apparatus according to claim 4, wherein:
the traveling state is at least one of a speed and an acceleration of the vehicle.

7. The driving assistance apparatus according to claim 1, wherein:
the rear condition detection unit includes a relative position calculation unit that calculates a relative positional relationship between the vehicle and the moving object; and
the control unit determines a content of the notification by the notification unit based on the relative positional relationship with the moving object calculated by the relative position calculation unit.

8. The driving assistance apparatus according to claim 1, wherein:
the checking action detection unit determines whether the driver has performed the action for checking behind the vehicle, based on at least one of a direction of a face and a direction of a line of sight of the driver.

9. The driving assistance apparatus according to claim 1, wherein:
the predetermined time is defined as a first threshold time; and
the control unit controls the notification unit to perform the notification of presence of the moving object to the driver in a case where a condition that: the vehicle is in the traveling state; the moving object is disposed within the predetermined range behind the vehicle; and the driver has not checked behind the vehicle continues for a second threshold time longer than the first threshold time.

10. The driving assistance apparatus according to claim 1, wherein:
the control unit controls the notification unit to perform the notification of alert of presence of the moving object or the notification of warning having a higher urgency than the alert when the deceleration detection unit detects the deceleration of the vehicle in a case where a condition that: the vehicle is in the traveling state; the moving object is disposed within the predetermined range behind the vehicle; and the driver has not checked behind the vehicle continues for the predetermined time; and
the control unit controls the notification unit to perform a notice that has a mode less annoying than the alert and notifies the presence of the moving object under a condition where the vehicle is in the traveling state, the moving object is disposed within the predetermined range behind the vehicle, and the driver has not checked behind the vehicle, regardless of a duration time of the condition.
